(19) United States
(12) Patent Application Publication
(10) Pub. No.: US 2021/0158147 A1
(43) Pub. Date: May 27, 2021

(54) TRAINING APPROACH DETERMINATION FOR LARGE DEEP LEARNING MODELS

(71) Applicant: International Business Machines Corporation, Armonk, NY (US)

(72) Inventors: Saritha Vinod, Bangalore (IN); Yogish Sabharwal, Gurgaon (IN)

(21) Appl. No.: 16/695,629

(22) Filed: Nov. 26, 2019

(51) Int. Cl. G06N 3/08; G06N 3/04

(52) U.S. Cl. CPC G06N 3/08; G06N 3/04

(57) ABSTRACT

In an approach to determining an optimal training approach for a large deep learning model based on model characteristics and system characteristics. The one or more computer processors identify one or more model characteristics associated with a deep learning model. The one or more computer processors identify one or more system configurations associated with a system training the deep learning model. The one or more computer processors determine a training approach for the deep learning model utilizing a trained large model predictor fed with the one or more identified model characteristics and the one or more identified system configurations. The one or more computer processors train the deep learning model utilizing the determined training approach.

### BACKGROUND

The present invention relates generally to the field of deep learning, and more particularly to determining a training approach.

Deep learning is a branch of machine learning based on a set of algorithms that model high-level abstractions in data by using model architectures, with complex structures or otherwise, often composed of multiple non-linear transformations. Deep learning is part of a broader family of machine learning methods based on learning representations of data. An observation (e.g., an image) can be represented in many ways such as a vector of intensity values per pixel, or in a more abstract way as a set of edges, regions of particular shape, etc. Some representations make it easier to learn tasks (e.g., face recognition or facial expression recognition) from examples. Deep learning algorithms often use a cascade of many layers of nonlinear processing units for feature extraction and transformation. Each successive layer uses the output from the previous layer as input. The algorithms may be supervised or unsupervised, and applications include pattern analysis (unsupervised) and classification (supervised). Deep learning models include Artificial Neural Networks (ANNs) inspired by information processing and distributed communication nodes in biological systems. ANNs have various differences from biological brains.

### SUMMARY

Embodiments of the present invention disclose a computer-implemented method, a computer program product, and a system for determining an optimal training approach for a large deep learning model based on model characteristics and system characteristics. The computer-implemented method includes one or more computer processers identifying one or more model characteristics associated with a deep learning model. The one or more computer processors identify one or more system configurations associated with a system training the deep learning model. The one or more computer processors determine a training approach for the deep learning model utilizing a trained large model predictor fed with the one or more identified model characteristics and the one or more identified system configurations. The one or more computer processors train the deep learning model utilizing the determined training approach.

### BRIEF DESCRIPTION OF THE DRAWINGS

FIG. 1 is a functional block diagram illustrating a computational environment, in accordance with an embodiment of the present invention;

FIG. 2 is a flowchart depicting operational steps of a program, on a server computer within the computational environment of FIG. 1, determining an optimal training approach for a large deep learning model based on model characteristics and system characteristics, in accordance with an embodiment of the present invention; and

FIG. 3 is a block diagram of components of the server computer, in accordance with an embodiment of the present invention.

### DETAILED DESCRIPTION

Several distinct characteristics define a training performance of a model. Identifying said characteristics and classifying possible training approaches that maximizes the training performance while retaining high levels of accuracy is a daunting task for most users. Traditionally, determining a training approach for a model is solved using a trial and error method. It is not possible to manually take into consideration all possible characteristics of a model and system necessary in order to determine an optimal training approach. Traditional methods that identify training approaches are often ineffective and resource intensive due to the fact that for any given deep learning (DL) model and a dataset, there are an exponential number of choices, adjustments, and considerations affecting a plurality of training parameters. Embodiments of the present invention allow for an automatic selection of a DL training approach for large models that maximizes performance. Embodiments of the present invention improve efficiency by automatically predicting model characteristics and correlating model characteristics with underlying system characteristics, allowing the invention to determine an optimal training approach. Embodiments of the present invention improve system efficiency by exploiting the system characteristics based on predictions made by the invention. Embodiments of the present invention adjust one or more system parameters and settings based on predicted model characteristics. Embodiments of the present invention recognize that system resources are conserved and available for other computational workloads by determining an optimal training approach and reducing the amount of required training time. Implementation of embodiments of the invention may take a variety of forms, and exemplary implementation details are discussed subsequently with reference to the Figures.

The present invention will now be described in detail with reference to the Figures.

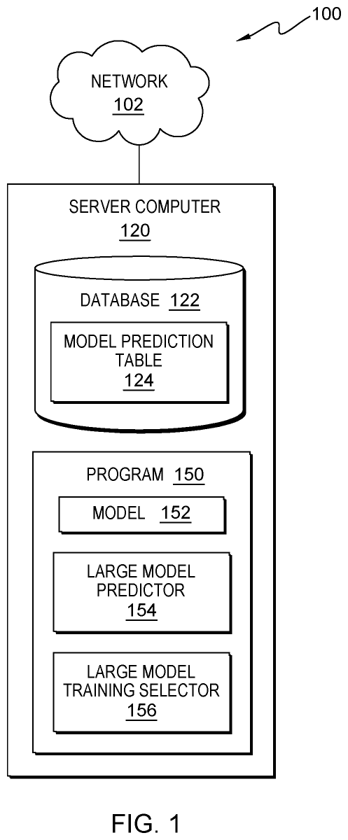

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

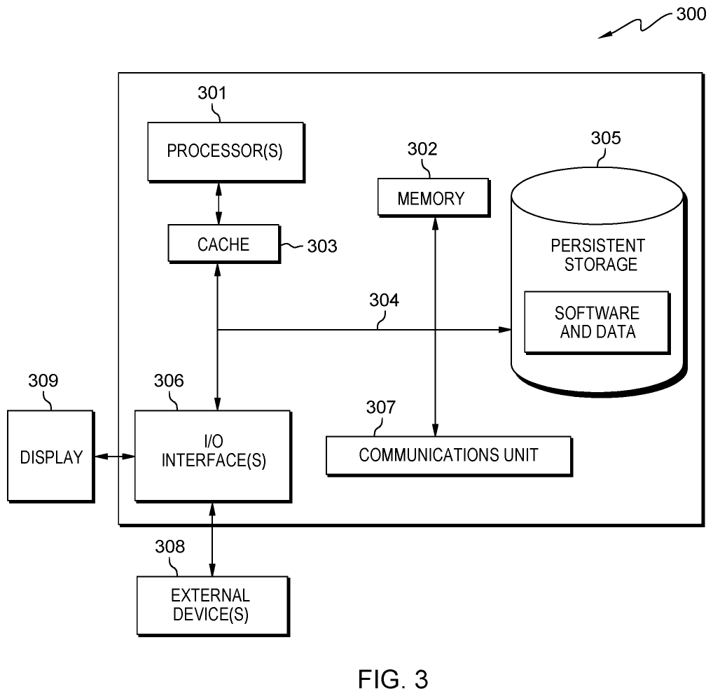

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes database 122 and program 150. In other embodiments, server computer 120 may contain other applications, databases, programs, etc. which have not been depicted in computational environment 100. Server computer 120 may include internal and external hardware components, as depicted, and described in further detail with respect to FIG. 3.

Database 122 is a repository for data used by program 150. In the depicted embodiment, database 122 resides on server computer 120. In another embodiment, database 122 may reside on computing device 110 or elsewhere within computational environment 100 provided program 150 has access to database 122. A database is an organized collection of data. Database 122 can be implemented with any type of storage device capable of storing data and configuration files that can be accessed and utilized by program 150, such as a database server, a hard disk drive, or a flash memory. In an embodiment, database 122 stores data used by program 150, such as historical deep learning model assessments and deployments. In the depicted embodiment, database 122 contains model prediction table 124.

Model prediction table (MPT) 124 contains data maintained and utilized by program 150, such as a plurality of model characteristics and a plurality of system categories, wherein each plurality contains an additional associated plurality of descriptive features. In an embodiment, model prediction table 124 contains data corresponding to a plurality of model characteristics including, but not limited to, model configuration (i.e., number of neurons, number of layers, tensor size, numbers of activations, parameter size, trainable parameters, and non-trainable parameters), model execution (i.e., CPU utilization, GPU utilization, GPU memory utilization, CPU memory utilization, and number of spawned CPU processes), model characteristics (i.e., time per iteration, CPU-GPU communication time, GPU compute time, CPU time utilization, scaling efficiency for multiple GPUs, and network latency), model convergence hyperparameters (i.e., batch size, training samples, evaluation samples, loss function, optimizer, learning rate, and momentum), data configuration (i.e., dataset size and data processing time). The system used for training is a significant factor and introduces numerous configurations that impact model training performance (e.g., training accuracy, training required resources, training duration, etc.). In an embodiment, model prediction table 124 contains data corresponding to a plurality of system configurations including, but not limited to, central processing unit (CPU) configurations (i.e., number of CPU cores, number of threads per CPU core, non-uniform memory access (NUMA) nodes, remote memory access latency, memory bandwidth, CPU-GPU link bandwidth/latency, and CPU-CPU interconnection bandwidth/latency) and graphical processing unit (GPU) configurations (i.e., number of GPUs, GPU compute capability (FLOPS), available GPU memory, GPU topology, GPU-GPU link bandwidth, and GPU-GPU link latency).

In various embodiments, MPT 124 contains model performance data including, but not limited to, predictive accuracy (e.g., Brier scores, Gini coefficients, discordant ratios, C-statistic values, net reclassification improvement indexes, receiver operating characteristics, generalized discrimination measures, Hosmer-Lemeshow goodness of fit values, etc.), error rates (e.g., root mean squared error (RMSE), mean absolute error, mean absolute percentage error, mean percentage error, etc.), precision, overfitting considerations, and model fitness. Based on the type of the model, program 150 determines appropriate model performance methods and techniques (e.g., testing/validation algorithms, associated data types, features, and vectors) that best capture a predictive effectiveness of a model.

In another embodiment, instances of MPT 124 contain links to other instances of MPT 124 that are relevant to one or more model features, statistics, and/or characteristics. In various embodiments, MPT 124 contains a universally unique identifier (UUID) for every referenced model and a globally unique identifier (GUID) for every model group. In one embodiment, MPT 124 contains references or link to a plurality of environments, systems, and servers (e.g., production, testing, auxiliary, etc.) associated with, or intended for, a model. In various embodiments, the MPT 124 contains links to related or historical models. In an embodiment, MPT 124 contains one or more examples, sets of training data, data structures, and/or variables used to fit parameters of a specified model. The contained data comprises of pairs of input vectors with associated output vectors. In an embodiment, MPT 124 may contain one or more sets of one or more instances of unclassified or classified (e.g., labelled) data, hereinafter referred to as training statements. Program 150 utilizes the aforementioned training sets to train large model predictor (LMP) 154.

Model 152 is representative of a model utilizing deep learning techniques to train, calculate weights, ingest inputs, and output a plurality of solution vectors. In an embodiment, model 152 is comprised of any combination of deep learning model, technique, and algorithm (e.g., decision trees, Naive Bayes classification, support vector machines for classification problems, random forest for classification and regression, linear regression, least squares regression, logistic regression). In an embodiment, model 152 utilizes transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. In the depicted embodiment, model 152 is a recurrent neural network (RNN) trained utilizing supervised training methods.

Large model predictor (LMP) 154 predicts whether a specified deep learning model satisfies the characteristics of a large model. In an embodiment, a large model comprises a deep learning model that due to a plurality of model characteristics (e.g., training sets, numbers of layers, batch sizes, etc.) and system considerations (e.g., GPU specifications, etc.), said model requires a specific approach to provide an efficient and stable training. In an embodiment, if a model is predicted to be a large model, then program 150 invokes large model training selector (LMTS) 156 and providing parameters necessary to select an optimal training approach (e.g., fastest method requiring few resources while maintain high training accuracy (e.g., greater than 95% accuracy, etc.), based on user parameters, system specifications, etc.). In an embodiment, LMP 154 is a neural network trained with historical model and system configurations with training approaches as labels. In an alternative embodiment, LMP 154 is a rule-based database.

Large model training selector (LMTS) 156 analyzes one or more inputs fed by LMP 154 to determine and select an optimal training approach based on system configurations and model characteristics. In an embodiment, LMTS 156 can select from a plurality of training approaches and model adjustments including, but not limited to, parallelization criteria (e.g., model and data parallelism), large model support, gradient checkpointing (e.g., re-computation), large model supports with parallelism, gradient checkpointing with model parallelism, and utilizing host memory as swap space. Each training approach and adjustment has associated model characteristics and an execution impact; model parallelism satisfies models that are too large to fit into the memory of a single GPU, here, larger batches sizes for convergence require layer to layer communication, data parallelism satisfies models that are too large to fit into the memory of a single GPU, here, larger batches sizes for convergence require CPU-GPU communication, GPU-GPU communication and larger GPU memory requirements, large model support satisfies models that are too large to fit into the memory of a single GPU, here, larger batches sizes for convergence require additional a high bandwidth CPU-GPU link, gradient checkpointing satisfies models that are too large to fit into the memory of a single GPU requiring additional computation overhead in the GPU and increases GPU memory, large model support with model parallelism satisfies large models with very large single layers requiring, additional layer to layer and CPU-GPU communication (e.g., high bandwidth links), and gradient checkpointing with model parallelism satisfies large models with large single layers that require additional computational overhead in the GPU and increased layer to layer communication. LMTS 156 utilizes the outputs of LMP 154 to determine an optimal training approach and associated adjustments for a specified deep learning model.

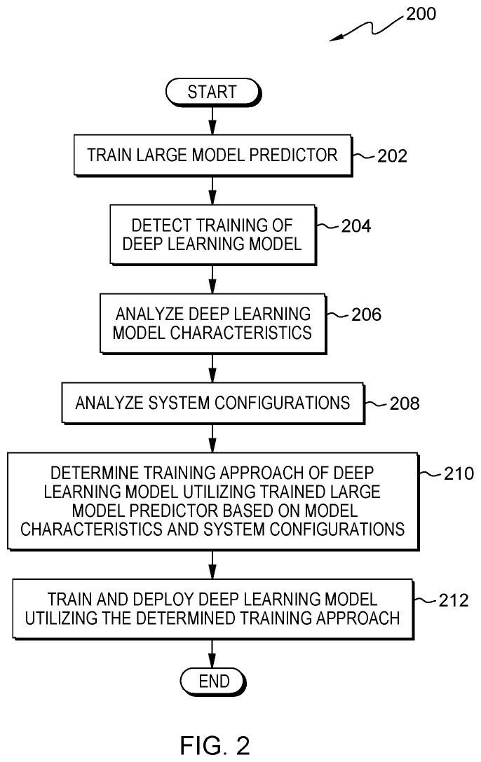

Program 150 is a program for determining an optimal training approach for a large deep learning model based on model characteristics and system characteristics. In various embodiments, program 150 may implement the following steps: identify one or more model characteristics associated with a deep learning model; identify one or more system configurations associated with a system training the deep learning model; determine a training approach for the deep learning model utilizing a trained large model predictor fed with the one or more identified model characteristics and the one or more identified system configurations; train the deep learning model utilizing the determined training approach. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. Program 150 is depicted and described in further detail with respect to FIG. 2.

The present invention may contain various accessible data sources, such as database 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 is a flowchart depicting operational steps of program 150 for determining an optimal training approach for a large deep learning model based on model characteristics and system characteristics, in accordance with an embodiment of the present invention.

Program 150 trains a large model predictor (step 202). In an embodiment, program 150 creates LMP 154 (a large model predictor) as a rule-based database containing one or more sets of chain-based rules (e.g., configuration and training approach pairs) dictating which features and categories result in an optimal training approach. In another embodiment, program 150 utilizes database 122 to train LMP 154 as a neural network prediction model. Program 150 trains LMP 154 utilizing training data contained within MPT 124. In an embodiment, program 150 maintains one or more sets of models wherein each set shares training sets, machine learning techniques, and deep learning structures and/or architectures (e.g., deep Boltzmann machines, deep convolutional networks, etc.) but the utilized training approach is distinct. Program 150 trains LMP 154 by utilizing a plurality of training methods (e.g., supervised, unsupervised, etc.) based on constructed feature vectors contained within MPT 124. In an embodiment, program 150 trains LMP 154 with a plurality of feature vectors originating from the sets extracted from the training data and associated label located in MPT 124.

Program 150 determines appropriate training methods based on the model type of LMP 154. For example, if LMP 154 is a recurrent neural network, then program 150 utilizes a supervised training method. In the depicted embodiment, program 150 utilizes processed training sets to perform a supervised training of LMP 154. In an embodiment, training sets include historical models and associated training approaches. In this embodiment, historical models include feature sets that include model and system data described in MPT 124. As would be recognized by one skilled in the art, supervised training determines the difference between a prediction (i.e., determined training approach) and a target (i.e., the error, actual training approach), and, in the case of a neural network, back-propagates the difference through the layers such that said model “learns”. In an embodiment, program 150 determines whether a sufficient accuracy is obtained by utilizing test sets and the associated test labels. In another embodiment, program 150 utilizes cross-entropy (e.g., Kullback-Leibler (KL) divergence, etc.) as a loss function to determine the level of accuracy of the model. In this embodiment, program 150 compares a predicted sequence (e.g., predicted training approach) with an expected sequence (e.g., expected training approach). In yet another embodiment, program 150 may utilize a cross-entropy loss value to calculate error rate which further denotes a level of accuracy of the model. If a calculated accuracy is insufficient, then program 150 continues with supervised training. If the calculated accuracy is determined sufficient, then program 150 ends the training process.

Program 150 detects deep learning model training (step 204). In an embodiment, program 150 continuously monitors a model training application or service. In this embodiment, program 150 detects when a new model is commencing training, and/or the training application or service notifies program 150. In various embodiment, program 150 suspends a training of the model until program 150 determines an optimal training approach and completes. In another embodiment, a user initiates the training of a deep model and notifies program 150 of such training. In various embodiments, program 150 detects an addition or modification of a plurality of training sets or statements. Responsive to detecting a training of a deep learning model, program 150 extracts model information such as the intended training approach, required completion time, required accuracy scores, required precision scores, targeted training environment/system, intended deployment environment, etc. Program 150 commences model initialization responsive to extracting model information.

Program 150 analyzes deep learning model characteristics (step 206). In an embodiment, program 150 identifies and analyzes the initialized deep learning model for the model characteristic information stored and contained within MPT 124. In this embodiment, program 150 predicts and analyzes the deep learning model characteristics, such as model configuration (i.e., number of neurons, number of layers, tensor size, numbers of activations, parameter size, trainable parameters, and non-trainable parameters), model execution (i.e., CPU utilization, GPU utilization, GPU memory utilization, CPU memory utilization, and number of spawned CPU processes), model characteristics (i.e., time per iteration, CPU-GPU communication time, GPU compute time, CPU time utilization, scaling efficiency for multiple GPUs, and network latency), model convergence hyperparameters (i.e., batch size, training samples, evaluation samples, loss function, optimizer, learning rate, and momentum), data configuration (i.e., dataset size and data processing time). For example, program 150 analyzes the data contained in one or more training sets to calculate the dataset size and the time it would take to process said data. In an embodiment, training set statistics may include, but are not limited to, training set size, total training statements, total training labels, frequency of training statements associated with each training label, global training statement ratios, etc. In various embodiments, program 150 utilizes references of historical models to predict any missing or erroneous values. In an embodiment, program 150 stores the analyzed information in MPT 124. In another embodiment, program 150 processes and creates a plurality of representative vectors based on the analyzed information.

Program 150 analyzes system configurations (step 208). In an embodiment, program 150 identifies and analyzes a training environment/system associated with a training of a deep learning model for the system configuration information stored and contained within MPT 124. Program 150 may receive a targeted training system from a user. In an embodiment, program 150 identifies a training system when program 150 detected a deep learning model, as discussed in step 204. Program 150 determines capabilities of a training system/environment. In an embodiment, the capabilities include, but are not limited to, CPU configurations (i.e., number of CPU cores, number of threads per CPU core, non-uniform memory access (NUMA) nodes, remote memory access latency, memory bandwidth, CPU-GPU link bandwidth/latency, and CPU-CPU interconnection bandwidth/latency) and graphical processing unit (GPU) configurations (i.e., number of GPUs, GPU compute capability (FLOPS), available GPU memory, GPU topology, GPU-GPU link bandwidth, and GPU-GPU link latency). In an embodiment, program 150 determines system capabilities and configurations by pinging and polling said system. For example, a system responds with device identification information, which may include capability parameters, to program 150 after a successful ping request. In another embodiment, program 150 identifies a system utilizing a unique product identifier, manufacturer part number, and/or part number. In a further embodiment, program 150 retrieves a technical specification of the identified system from a plurality of sources including, but not limited to, a manufacturer or third-party website/repository. In various embodiments, the user inputs the capabilities of the system into program 150. In various embodiments, program 150 utilizes references of historical systems to predict any missing or erroneous values. In various embodiments, program 150 stores any determined configuration and capabilities in MPT 124. In another embodiment, program 150 processes and creates a plurality of representative vectors based on the analyzed information.

Program 150 determines a training approach utilizing trained large model predictor based on the analyzed deep learning model characteristics and the analyzed system configurations (step 210). In an embodiment, program 150 inputs the analyzed information, as discussed in steps 206 and 208, into trained LMP 154 to determine an optimal training approach. Program 150 utilizes LMTS 156 to select one or more training approaches based on the output of LMP 154 and user considerations such as training deadlines, deployment times, or accuracy requirements. Program 150 utilizes LMP 154 to consider plurality of considerations and features that affect training performance and generate probabilities (e.g., output, classifications, etc.) associated with each training approach. In an embodiment, training approaches include, but are not limited to, parallelization criteria (e.g., model and data parallelism), large model support, gradient checkpointing (e.g., re-computation), large model supports with parallelism, gradient checkpointing with model parallelism, and utilizing host memory as swap space. LMTS 156 receives output probabilities from LMP 154 and utilizes the probabilities to rank associated training approaches. In an embodiment, LMTS 156 verifies that top ranked training approaches conform with system specifications and user requirements. In various embodiments, program 150 establishes a predefined probability threshold (e.g., greater than 80%, etc.) where program 150 only considers, analyzes, reviews, and/or verifies training approaches that meet or exceed the probability threshold. In an embodiment, the probability threshold can be set by a user or dynamically adjusted by user considerations and requirements (e.g., deadlines, preferred training approaches, etc.). In another embodiments, program 150, automatically, selects the highest ranked training approach. In various embodiments, program 150 modifies and adjusts one or more system parameters and settings based on a determined training approach. For example, program 150 may delay, suspend, and/or restrict other applications and programs from utilizing GPU memory until a training of the model is complete. In another embodiment, if a targeted training system has a suboptimal configuration, program 150 may identify one or more suitable systems capable of completing the determined optimal training approach.

In an example scenario, program 150 detects and initializes a deep learning model. Program 150 extracts and predicts model characteristics and system configurations, calculating whether the GPU memory of the training system is sufficient for the input batch size and any required parallelization. Program 150, then, determines a largest tensor size by analyzing model layers and weights and compares the tensor size with available GPU memory. If the model requires more GPU memory than is available, program 150 classifies the model as a large model. Program 150 will further assess current system capabilities including CPU-GPU link bandwidth and communication time requirements. If the CPU-GPU link is a high bandwidth link, then program 150 determines a training approach that includes host memory with swapping. If the model is large batch sizes, swapping will occur frequently impacting overall training throughput (e.g., performance). Here, program 150 determines a hybrid approach, swapping with gradient checkpointing. If program 150 determines that a CPU-GPU link bandwidth of the system is low or insufficient, then program 150 determines a training approach with gradient checkpointing. If program 150 determines that a single layer GPU memory requirement is high and the largest tensor size for a layer is larger than available GPU memory, then program 150 determines a training approach utilizing model parallelism and splits the layer parameters into multiple GPUs, thereby reducing the memory requirement.

Program 150 trains and deploys deep learning model utilizing the determined training approach (step 212). In an embodiment, program 150 trains the detected deep learning model utilizing the determined training approach. Responsive to a completion of training, program 150 deploys the model to a production environment or server. In another embodiment, program 150 determines which deployment environment to deploy a trained deep learning model from a plurality of deployment environments (e.g., test, production, backup server, containers, or virtual machines). For example, if a model requires 20 gigabytes of storage space to operate and a specified production environment only has 10 gigabytes available, then program 150 eliminates said production environment and selects an environment that can support said model. In various embodiments, program 150 selects a deployment environment that has sufficient specifications and resources required for the training approach. In an embodiment, a user instructs program 150 to deploy the trained deep learning model to a specific environment. In another embodiment, a targeted environment is predetermined or associated with the deep learning model. Program 150 logs aforementioned results into MPT 124 and retrains large model predictor with adjusted MPT 124.

Accordingly, in this step, program 150, automatically, trains a model utilizing the determined optimal training approach based on model characteristics and system configurations. Here, a determined optimal training approach conserves system resources and computational time by reducing an amount of required training time thus allowing system resources to become available sooner than a suboptimal training approach. Additionally, program 150 conserves CPU resources by offloading training workloads to one or more GPUs.

FIG. 3 depicts a block diagram of components of server computer 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 120 each include communications fabric 304, which provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications, and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of computer processor(s) 301 by holding recently accessed data, and data near accessed data, from memory 302.

Program 150 may be stored in persistent storage 305 and in memory 302 for execution by one or more of the respective computer processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program 150 may be downloaded to persistent storage 305 through communications unit 307.

I/O interface(s) 306 allows for input and output of data with other devices that may be connected to server computer 120. For example, I/O interface(s) 306 may provide a connection to external device(s) 308, such as a keyboard, a keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 305 via I/O interface(s) 306. I/O interface(s) 306 also connect to a display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying, by one or more computer processors, one or more model characteristics associated with a deep learning model;
identifying, by one or more computer processors, one or more system configurations associated with a system training the deep learning model;
determining, by one or more computer processors, a training approach for the deep learning model utilizing a trained large model predictor fed with the one or more identified model characteristics and the one or more identified system configurations; and
training, by one or more computer processors, the deep learning model utilizing the determined training approach.

2. The method of claim 1, wherein determining the training approach for the deep learning model utilizing the trained large model predictor fed with the one or more identified model characteristics and the one or more identified system configurations, comprises:
generating, by one or more computer processors, a plurality of probabilities associated with one or more respective training approaches utilizing the trained large model predictor;
ranking, by one or more computer processors, one or more training approaches based on respective generated probability; and
automatically selecting, by one or more computer processors, a highest ranked training approach.

3. The method of claim 1, further comprising:
responsive to a training completion, deploying, by one or more computer processors, the trained deep learning model to one or more environments.

4. The method of claim 1, wherein training approaches are model parallelism, data parallelism, large model support, gradient checkpointing, large model supports with parallelism, gradient checkpointing with model parallelism, or utilizing host memory as swap space.

5. The method of claim 1, wherein system configurations are CPU configurations information regarding a number of CPU cores, a number of threads per CPU core, non-uniform memory access nodes, a remote memory access latency, a memory bandwidth, a CPU-GPU link bandwidth and latency, and CPU-CPU interconnection bandwidth and latency; or graphical processing unit configurations information regarding a number of GPUs, a GPU compute capability, a GPU memory, a GPU topology, a GPU-GPU link bandwidth, and a GPU-GPU link latency.

6. The method of claim 1, wherein model characteristics are model information regarding a number of neurons, a number of layers, a tensor size, a number of activations, a parameter size, trainable parameters, and non-trainable parameters; model execution information regarding a CPU utilization, a GPU utilization, a GPU memory utilization, a CPU memory utilization, and a number of spawned CPU processes; model considerations regarding a time per iteration, a CPU-GPU communication time, a GPU compute time, a CPU time utilization, scaling efficiency for multiple GPUs, and a network latency; model convergence information regarding hyperparameters, a batch size, training samples, evaluation samples, a loss function, optimizer, a learning rate, and momentum; or data configuration containing information regarding a dataset size and a data processing time.

7. The method of claim 1, wherein the large model predictor is a neural network.

8. The method of claim 7, wherein the neural network is trained utilizing historical model characteristics, historical system configurations, and associated training approach labels.

9. The method of claim 1, wherein determining the training approach for the deep learning model utilizing the trained large model predictor fed with the one or more identified model characteristics and the one or more identified system configurations, comprises:
maintaining, by one or more computer processors, one or more sets of deep learning models wherein each set shares training sets, machine learning techniques, and deep learning structures but utilizes a distinct training approach.

10. A computer program product comprising:
one or more computer readable storage media and program instructions stored on the one or more computer readable storage media, the stored program instructions comprising:
program instructions to identify one or more model characteristics associated with a deep learning model;
program instructions to identify one or more system configurations associated with a system training the deep learning model;
program instructions to determine a training approach for the deep learning model utilizing a trained large model predictor fed with the one or more identified model characteristics and the one or more identified system configurations; and
program instructions to train the deep learning model utilizing the determined training approach.

11. The computer program product of claim 10, wherein the program instructions, to determine the training approach for the deep learning model utilizing the trained large model predictor fed with the one or more identified model characteristics and the one or more identified system configurations, comprise:
program instructions to generate a plurality of probabilities associated with one or more respective training approaches utilizing the trained large model predictor;
program instructions to rank one or more training approaches based on respective generated probability; and
program instructions to automatically select a highest ranked training approach.

12. The computer program product of claim 10, wherein the program instructions, stored on the one or more computer readable storage media, comprise:
program instructions to, responsive to a training completion, deploy the trained deep learning model to one or more environments.

13. The computer program product of claim 10, wherein the large model predictor is a neural network.

14. The computer program product of claim 13, wherein the neural network is trained utilizing historical model characteristics, historical system configurations, and associated training approach labels.

15. A computer system comprising:
one or more computer processors;
one or more computer readable storage media; and
program instructions stored on the computer readable storage media for execution by at least one of the one or more processors, the stored program instructions comprising:
program instructions to identify one or more model characteristics associated with a deep learning model;
program instructions to identify one or more system configurations associated with a system training the deep learning model;
program instructions to determine a training approach for the deep learning model utilizing a trained large model predictor fed with the one or more identified model characteristics and the one or more identified system configurations; and
program instructions to train the deep learning model utilizing the determined training approach.

16. The computer system of claim 15, wherein the program instructions, to determine the training approach for the deep learning model utilizing the trained large model predictor fed with the one or more identified model characteristics and the one or more identified system configurations, comprise:
program instructions to generate a plurality of probabilities associated with one or more respective training approaches utilizing the trained large model predictor;
program instructions to rank one or more training approaches based on respective generated probability; and
program instructions to automatically select a highest ranked training approach.

17. The computer system of claim 15, wherein the program instructions, stored on the one or more computer readable storage media, comprise:
program instructions to, responsive to a training completion, deploy the trained deep learning model to one or more environments.

18. The computer system of claim 15, wherein the large model predictor is a neural network.

19. The computer system of claim 18, wherein the neural network is trained utilizing historical model characteristics, historical system configurations, and associated training approach labels.

20. The computer system of claim 15, wherein training approaches are model parallelism, data parallelism, large model support, gradient checkpointing, large model supports with parallelism, gradient checkpointing with model parallelism, or utilizing host memory as swap space.
